(19) United States
(12) Patent Application Publication
(10) Pub. No.: US 2014/0044864 A1
(43) Pub. Date: Feb. 13, 2014

(54) METHOD OF MASKING WALLS OF A SPRAY BOOTH AND KIT OF PARTS FOR USE THEREIN

(71) Applicants: Colin D. Sinclair, Coventry (GB); Gary N. Brotherton, Warwickshire (GB); Kin-Chau Chan, Tamworth (GB); Jeffrey J. Schwab, Inver Grove Heights, MN (US); Craig G. Appleby, Castleford (GB); Anna B. Baker, Nottingham (GB)

(72) Inventors: Colin D. Sinclair, Coventry (GB); Gary N. Brotherton, Warwickshire (GB); Kin-Chau Chan, Tamworth (GB); Jeffrey J. Schwab, Inver Grove Heights, MN (US); Craig G. Appleby, Castleford (GB); Anna B. Baker, Nottingham (GB)

(73) Assignee: 3M INNOVATIVE PROPERTIES COMPANY, ST. PAUL, MN (US)

(21) Appl. No.: 13/823,787

(22) PCT Filed: Aug. 29, 2011
(86) PCT No.: PCT/US11/49481

§ 371 Date: Oct. 4, 2013

(30) Foreign Application Priority Data
Sep. 17, 2010 (GB) 1015568.7

(51) Int. Cl. C09D 7/12

(52) U.S. Cl. CPC C09D 7/12
USPC 427/8; 524/111; 106/209.1; 106/203.2; 106/205.1

(57) ABSTRACT

The present application discloses a method of masking an interior surface of a spray booth, the method comprising: —providing a masking liquid comprising one or more polymers dispersed or dissolved in water, a base in amount sufficient to such that the pH of the masking liquid is more than 7 and a pH indicator that is colored at the pH of the masking liquid; —applying the masking liquid to at least part of an interior surface of the spray booth; —allowing the applied masking liquid to dry whereby upon drying the pH indicator becomes colorless or substantially colorless and a clear transparent or translucent white masking coating is obtained.

### BACKGROUND

The present invention relates to the protection of interior surfaces such as wall, window, and adjacent floor surfaces in and around a paint spray booth. In particular, the present invention relates to a method of masking the interior surfaces of a spray booth and to a kit of parts for making a masking liquid for use in the method.

The manufacture of many goods requires the application of a decorative finish, either for appearance or protection. The application of a decorative finish is usually performed inside an enclosed area or spray booth. Generally, a spray booth encompasses a sealed chamber with a clean air supply and removal system. The item to be painted is placed inside the booth, and application of the paint is accomplished via hand or automatic spray equipment. Due to paint transfer efficiencies of usually 60% at best, a good deal of the sprayed paint becomes entrained in the booth air flow and ultimately is deposited on the interior surfaces and equipment inside the spray booth. This uncured paint “overspray” fouls the walls and floor and is easily tracked outside the paint booth by workers' shoes and equipment. If allowed to accumulate, this overspray limits visibility through windows in the spray booth, reduces airflow in the booth by narrowing the gap in floor grates, and creates unsafe work conditions by making walking surfaces and equipment slippery. Most spray booths comprise white colored interior surfaces so as to enable easy color matching.

To protect the white colored walls of spray booth from paint overspray, an aqueous liquid is used to cover the interior surfaces of the spray booth. These coating liquids are generally called booth coatings or masking liquids and are translucent white or clear transparent so as to retain the whiteness of the interior walls of the booth so as to enable an easy process of color matching of the substrate to be painted. The masking liquid is typically sprayed onto the white walls and the coating is then allowed to dry. Once dried, the coating acts as a barrier against paint overspray. When sufficient paint overspray gets deposited onto the wall, the “contaminated” coating is removed by washing off using water or peeling the coating.

In general, the application of such a translucent white or clear transparent coating on a white wall is difficult because of a lack in contrast between the painted and unpainted surface. The practitioner is thus faced with the challenge of assuring that enough masking liquid has been applied and that the masking coating does not contain defects. This tends to lead to an excessive use and application of the masking liquid.

### SUMMARY

It would now be desirable to find an improved method for applying a booth coating or masking liquid. In particular, such method should be compatible with existing application methods and masking liquids used. It would further be desirable that the method is cost effective and/or does not substantially add to the cost of masking liquids, particularly as those are only applied temporarily and need to be replaced on a more or less frequent basis. It would in particular be desirable that the obtained masking coating has substantially the same performance and appearance as current masking coatings in use and in particular it would be desired that the color matching ability is not impaired.

In one aspect there is provided a method of masking an interior surface of a spray booth, the method comprising:
providing a masking liquid comprising one or more polymers dispersed or dissolved in water, a base in amount sufficient to such that the pH of the masking liquid is more than 7 and a pH indicator that is colored at the pH of the masking liquid;
applying the masking liquid to at least part of an interior surface of the spray booth;
allowing the applied masking liquid to dry whereby upon drying the pH indicator becomes colorless or substantially colorless and a clear transparent or translucent white masking coating is obtained.

In another aspect, there is provided a kit of parts, the kit comprising separate first and second parts, the first part comprising a translucent white or clear transparent masking liquid comprising one or more polymers dispersed or dissolved in water and the second part comprising a base, and wherein either or both of said first and second part comprise a pH indicator that is colored at a pH of more than 7 and whereby upon mixing said first and second part, a pH of the masking liquid is obtained at which the pH indicator exhibits color thereby obtaining a colored masking liquid.

### DETAILED DESCRIPTION

It has been found that the method enables an easy application of the masking liquid, as the masking liquid during application, for example spraying, is colored and thus provides ample contrast to the typical white colored surface of the interior surfaces of the spray booth. Upon drying, it has been found that a pH shift towards a neutral or slight acidic pH occurs leading to the pH indicator in the masking liquid to change from its colored state to a colorless or substantially colorless state and hence following drying, the appearance of the masking or booth coating is substantially the same as that in absence of the pH indicator.

To avoid any substantial interference with other components of the masking liquid during storage, it will generally be preferred that the base be kept separate from the masking liquid and be mixed into the masking liquid only shortly before the masking liquid will be applied. When the amount of base generally necessary to color the masking liquid is present in the masking liquid during a substantial period of storage thereof, it has been observed that the indicator may gradually loose its color or in some circumstances, the shift from color to colorless may no longer be sufficiently complete following the application of the masking liquid and drying thereof. For example, the necessary base may be mixed with the masking liquid one or more hours before application of the masking liquid, up to for example several days or a week. The actual time following mixing and before application will depend on the particular composition of the masking liquid used.

Thus, in a particular aspect there is also provided a kit of parts for use with the method, the kit comprising separate first and second parts, the first part comprising a translucent white or clear transparent masking liquid comprising one or more polymers dispersed or dissolved in water and the second part comprising a base, and wherein either or both of said first and second part comprise a pH indicator that is colored at a pH of more than 7 and whereby upon mixing said first and second part, a pH of the masking liquid is obtained at which the pH indicator exhibits color thereby obtaining a colored masking liquid.

By the term “colored masking liquid” is meant a masking liquid that has a color other than white, typically a color resembling the color of the pH indicator used in its colored state.

The first and second part of the kit of parts are separate parts and they may for example be held in separate storage containers such as bottles.

The translucent white or clear transparent masking liquid for use in connection with the first part of the kit may be any known or commonly used masking liquid including those described in for example U.S. Pat. No. 6,232,392, US 2007/0207269, US 2002/0172770, US. Pat. No. 4,548,962 and EP 405341. The masking liquid comprises one or more polymers dissolved or dispersed in water. Typically, the polymers are film forming polymers and are water dispersible or soluble in water. Examples of polymers that may be used in the masking liquid include polyols such as polyvinylalcohols including polyvinylacetates of various degrees of hydrolization, polyvinylpyrrolidones (PVP), starches, celluloses including carboxymethyl cellulose, hydroxyethyl cellulose, hydroxypropyl cellulose, algins, dextrins, gum Arabic, alginic acid, a cellulose gum, acrylic polymers such as styrene/acrylic acid copolymers, alkali swellable copolymers of acrylic and polyester with fatty acid or alcohol moieties having from 14 to 30 carbon atoms like acrylate/steareth-itaconate copolymer and/or alkali swellable acrylate/Ceteth-itaconate copolymer and any combinations of any of the foregoing. Typically used are PVP polymers or polyvinyl alcohols. The polymers typically comprise from about 1% to about 50% (weight percent of the masking liquid), preferably from about 3% to about 25%, more preferably from about 5% to about 15% or 20%, and most probably from about 7% or 10% to about 12% or 15%.

Generally, the masking liquid will further comprise one or more surfactants. Suitable surfactants include siloxane-based surfactants including silicone polyoxyalkylene copolymers, organosilicone-polyether copolymer surfactants, and the like. In certain embodiments, preferred siloxane-based surfactants include BYK® surfactants available from BYK Chemie GmbH (West Germany). In certain embodiments, the siloxane based surfactants include BYK® 347. Other silicon surfactants can be identified for example in Hill (1999) Silicon Surfactants, Marcel Decker, New York. Further surfactants include, but are not limited to anionic surfactants (e.g., alkyl sulfates (e.g. RHODAPON(TM), ether sulfates (e.g., RHODAPEX(TM), sulfonates (e.g. RHODACAL(TM), dodecylbenzene sulfonates, alpha-olefin sulfonates, diphenyl oxide disulfonates, phosphate esters (e.g. Rhodafac™), carboxylates (e.g. Miranate TM), etc.), cationic surfactants (e.g., imidazolines (e.g. Miramine™), ethoxylated amines (e.g. Rhodameen™, etc.), non-ionic surfactants (e.g., nonylphenol ethoxylates (e.g. Igepal co series), octylphenol ethoxylates (e.g. Igepal CA series), nonionic esthers (e.g. Alkamuls™), oleyl alcohol thoxylates (e.g. Rhodasurf™, ethoxylated mercaptans (e.g. Alcodet™), capped ethoxylates (e.g. Antarox™), blocked polymers, etc.), and amphoteric surfactants (e.g., imidazoline derivatives (Miranoj™, fatty amine derivatives (e.g., Mirataine™), etc.). In certain embodiments, the masking composition includes nonionic alkyl aryl surfactants such as Triton CF-1O and CF-12 (Rohm & Haas, Philadelphia, Pa., U.S.A.). Also suitable is Triton X-I 00 and surfactants having fluorinated alkyl chains such as “Fluorad” products sold by 3M Co. (St. Paul, Minn., U.S.A.) and “Zonyl” products sold by DuPont Company (Wilmington, Del., U.S.A.) are also suitable. In addition, many embodiments include polyethoxy adducts or modified (poly)ethoxylates such as Triton DF-12 and DF-16 sold by Union Carbide (Danbury, Conn., U.S.A.). Other surfactants include nonylphenoxypolyethanol (such as IGEPAL CO-660 made by GAF), polyoxyalkylene glycol (such as Macol 18 and 19 made by Mazer Chemicals), acetylenic diol-based surfactants (such as Surfynol 104A made by Air Products), and the like. Surfactants are typically used in an amount of 0.05% by weight upto 5% by weight.

In certain embodiments, the masking liquid may further contain a plasticizer to provide toughness and flexibility and in particular to prevent cracking of the film during drying and subsequent handling Suitable plasticizers include, but are not limited to glycerine, sorbitol, sugars (e.g. glucose, sucrose, levulose, dextrose, etc.), urea, triethylene glycol, polyethylene glycol, and other water soluble plasticizers. These plasticizers may be used alone, or in combination with each other. One combination of plasticizers is urea in combination with glycerine or glycerine derivatives such as glycerine monostearate or glycerine monooleate. Another particular combination is glycerin in combination with sorbitol.

In a particular embodiment, the first part contains the pH indicator. Where the pH indicator is included in the masking liquid of the first part, the pH of the masking liquid will generally be such that the pH is in its colorless state such that the masking liquid remains translucent white or clear transparent. The pH indicator should be colored at a pH above 7, for example at a pH of at least 7.5, or at least 8 or at least 8.5 or at least 9. At a pH below the pH where the indicator is colored, the indicator should be colorless or substantially colorless. In a particular embodiment, the pH indicator will transition to colorless at a pH at or below 8.5, for example at or below 8 or at or below 7.5. In principle any pH indicator having a pH transition as above described may be used in this invention. Particularly suitable for use in connection with this invention are phthalein compounds or phthalein based indicators. Examples thereof include phenolphthalein, o-cresolphthalein, thymophthalein, alpha-naptholphtalein, xylenolphthalein, tetrabromophenolphthalein, guaiacolphthalein, dixylenolphthalein and carvacrolphthalein. Further suitable phthalein based indicators can be found in WO 06105191. Further indicators that may be used include ethyl-bis(2,4-dinitrophenyl)-acetate, nitramine, p-nitrobenzhydrazide, pinachrome and quinoline blue.

The pH indicator may not be readily soluble in water and will in such circumstances first be dissolved in a water miscible organic solvent. Suitable water-miscible organic solvents include in particular alcohols such as ethanol, isopropanol, n-propanol, n-butanol, methanol, glycols and glycerol and glycol ethers such as butyl diglycol and methoxy propanol, ketones such as acetone and acetylacetone, ethyl acetate and the like. Following dissolution of the indicator in a suitable organic solvent, water may be added thereto to obtain an aqueous solution of the indicator. The weight ratio of water-miscible organic solvent to water may vary widely and will depend on the particular indicator used. Generally the weight ratio of water-miscible organic solvent to water may be between 2:1 and 1:10. The amount of indicator in the indicator solution may vary widely and will depend on the desired amount in the final mixture following mixing of the first and second part. Generally, the desired amount when the two parts are mixed together is between 0.001% and 0.2% or between 0.01% and 0.1%.

In another embodiment, the pH indicator is included in the second part that contains the base. In yet a further embodiment the pH indicator may be included in both the first and second part. The second part of the kit of parts comprises a base so as to adjust the pH of the masking liquid to an alkaline pH at which the pH indicator is colored when the second part is mixed with the masking liquid of the first part. Suitable bases that may be used for this purpose include organic as well as inorganic bases. Examples include alkali and alkali earth metal hydroxides such as lithium hydroxide, sodium hydroxide, potassium hydroxide, magnesium hydroxide, strontium hydroxide, ammonium hydroxides, amines such as secondary and tertiary alkanol amines including diethanol amine and triethanol amine, cyclic amines such as for example morpholine, and carbonates such potassium or sodium bicarbonate. The amount of base used is such so as to obtain a desired pH. Typically, the pH of the resulting masking liquid will be at least 7.5, for example at least 8, or at least 8.5 or at least 9.

The invention is further illustrated with reference to the following examples without however the intention to limit the invention thereto. All parts and percentages are by weight unless otherwise indicated.

### Examples

A stock solution of phenolphthalein is prepared by dissolving 8 g of phenolphthalein powder in 200.8 g of Isopropyl alcohol (IPA). Once dissolved, this phenolphthalein/IPA solution was diluted down with an equal weight of deionized water. This resultant mixture is termed as the “phenolphthalein stock solution”.

A transparent clear masking liquid commercially available under the trade designation 3M™ Booth Coating PN 06839 from 3M Company was mixed with the required amount of the phenolphthalein stock solution to yield three different mixtures containing respectively 0.02%, 0.04% and 0.06% in phenolphthalein. The procedure to yield a booth coating solution containing 0.02%, 0.04% and 0.06% in phenolphthalein was achieved by mixing 18.7 g, 37.34 g and 56.6 g of the phenolphthalein stock solution, respectively, to the 3M™ Booth Coating PN 06839:

To the thus obtained mixture was added triethanolamine (TEA) (triethanol amine standard grade 85% from Univar Europe) in a weight ratio of TEA to masking liquid of 3:100. Upon addition, the masking liquid turns to a pink liquid. This coloured mixture was sprayed onto a white coloured painted metal panel. Soon upon spraying, the colour of the coating was visually observed subjectively (i.e. can the colour be seen easily) and measured using a colour photometer. The L value of the panel was measured before and after spraying and the difference “Delta L” (L reading after spraying—L reading before spraying) was recorded. Further, the L value after drying was measured as well and a Delta L value after drying was obtained (L reading after drying—L value reading before spraying) The Delta L value of for the 3 different mixtures obtained is set forth in below table. Additionally, as a reference, the Delta L values were also measured for the 3M™ Booth Coating PN 06839 to which no indicator had been added. The results for this reference are indicated as Reference in below table.

| | Delta L value | Delta L value |
|---|---|---|
| % indicator | (before drying) | (after drying) |
| 0.02% | −4.11 | −0.26 |
| 0.04% | −5.08 | −0.30 |
| 0.06% | −8.91 | −0.51 |
| Reference | −0.17 | −0.17 |

1. Method of masking an interior surface of a spray booth, the method comprising:
providing a masking liquid comprising one or more polymers dispersed or dissolved in water, a base in amount sufficient to such that the pH of the masking liquid is more than 7 and a pH indicator that is colored at the pH of the masking liquid;
applying the masking liquid to at least part of an interior surface of the spray booth;
allowing the applied masking liquid to dry whereby upon drying the pH indicator becomes colorless or substantially colorless and a clear transparent or translucent white masking coating is obtained.

2. Method according to claim 1 wherein the masking liquid is provided by mixing a translucent white or clear transparent masking liquid comprising one or more polymers dispersed or dissolved in water with an additive comprising said base and wherein said pH indicator is present in either or both of said translucent white or clear transparent masking liquid and said additive.

3. Method according to claim 2 wherein the pH indicator is contained in the masking liquid and said masking liquid has a pH such that the pH indicator is colorless.

4. Method according to claim 2 wherein the pH indicator is dissolved in the masking liquid or additive with the aid of a water-miscible organic solvent.

5. Method according to claim 4 wherein said water-miscible solvent is selected from the group consisting of alcohols, ketones and ethylacetate.

6. Method according to claim 1 wherein the pH indicator becomes colorless at a pH below 8.5.

7. Method according to claim 1 wherein the pH indicator is a phthalein compound.

8. Method according to claim 1 wherein said one or more polymers are selected from polyvinylacohols, polyvinypyrolidones, polyvinyl acetates, starches, celluloses, arabic gum, algins, dextrins and acrylic polymers.

9. Kit of parts for making a colored masking liquid, the kit comprising separate first and second parts, the first part comprising a translucent white or clear transparent masking liquid comprising one or more polymers dispersed or dissolved in water and the second part comprising a base, and wherein either or both of said first and second part comprise a pH indicator that is colored at a pH of more than 7 and whereby upon mixing said first and second part, a pH of the masking liquid is obtained at which the pH indicator exhibits color thereby obtaining a colored masking liquid.

10. Kit of parts according to claim 9 wherein the part containing the pH indicator comprises a water-miscible organic solvent.

11. Kit of parts according to claim 10 wherein said water-miscible solvent is selected from the group consisting of alcohols, ketones and ethylacetate.

12. Kit of parts according to claim 9 wherein the pH indicator becomes colorless at a pH below 8.5.

13. Kit of parts according to claim 9 wherein the pH indicator is a phthalein compound.

14. Kit of parts according to claim 9 wherein said one or more polymers are selected from polyvinylacohols, polyvinypyrrolidones, polyvinylacetates, starches, celluloses, arabic gum, algins, dextrins and acrylic polymers.

15. A masking liquid comprising one or more polymers dispersed or dissolved in water, a base in amount sufficient to such that the pH of the masking liquid is more than 7 and a pH indicator that is colored at the pH of the masking liquid.
